(19) United States
(12) Patent Application Publication
(10) Pub. No.: US 2004/0026325 A1
(43) Pub. Date: Feb. 12, 2004

(54) Device for treating drinking water

(76) Inventors: Klaus Leiter, Vols (AU); Gerhard Walder, Zirl (AU)

Correspondence Address: Mark D Lorusso, Lorusso & Loud, 440 Commercial Street, Boston, MA, 02109, US

(21) Appl. No.: 10/432,976

(22) PCT Filed: Nov. 19, 2001
(86) PCT No.: PCT/AT01/00363

(30) Foreign Application Priority Data
Nov. 23, 2000 (AT) A 1970/2000

(51) Int. Cl. B01D 15/00

(52) U.S. Cl. 210/660

(57) ABSTRACT

The invention relates to a device for the physical treatment of drinking water, preferably using a catalytically active ion exchanger resin (5), said treatment device being located inside a heating device for hot water.

The present invention relates to a device for the treatment of drinking water. PCT Application WO 99/48822 describes how a weakly acidic ion exchange resin in the Ca-form at its surface catalytically triggers precipitation of lime from a lime-containing solution. This process can be used for physical water treatment: the lime seed crystals formed on the surface of the catalytically active granulate easily become detached from the surface and are even centres of crystallization in the supersaturated water. The growth of these centres of crystallization binds the excess calcium and carbonate ions, and precipitation processes on pipe and boiler walls are permanently suppressed in this way. In PCT Application WO 99/48822 there are also technical descriptions of how preferably water treatment devices with this catalyst material are designed and used in the drinking water installation. Essentially these water treatment devices are constructed from a pressure-resistant container, a perforated floor and a granulate-retaining filter element. It was originally intended to incorporate this catalyst technology into the cold water section of the drinking water system. It was subsequently found that this catalyst granulate is used most effectively in the area of hot water in combination with a hot water reservoir, for the following reasons:

The degree of supersaturation of the hard water is higher in the area of hot water; correspondingly the probability of seed crystal formation also increases at the surface of the catalyst granulate.

The growth kinetics of the lime seed crystals formed are considerably more rapid at higher temperatures, i.e. lime seed crystals formed are more rapidly available as centres of crystallization.

In drinking water heating systems with reservoirs, the. process water. has a distinctly longer average residence time in the system. This residence time allows a longer treatment period for the water. An efficient water treatment is therefore also possible with small, compact catalysts.

Warm/hot water is ideal for disinfecting the catalyst granulate; from the point of view of hygiene, disinfection helps to ensure safe operation in the area of drinking water, due to the large surface area of the material.

These are the reasons why the catalyst granulate is preferably used in the hot water section. In order to guarantee the protection of the whole drinking water heating system, it is necessary to bring all the hot water into contact with the catalyst. This requirement is satisfied, for example, in that the water treatment device is either introduced into an existing circulation pipe, and the hot water is circulated with a circulation pump or alternatively a separate bypass pipe via the hot water reservoir is constructed specifically for it, and the water treatment device together with a circulation pump is integrated into this pipe.

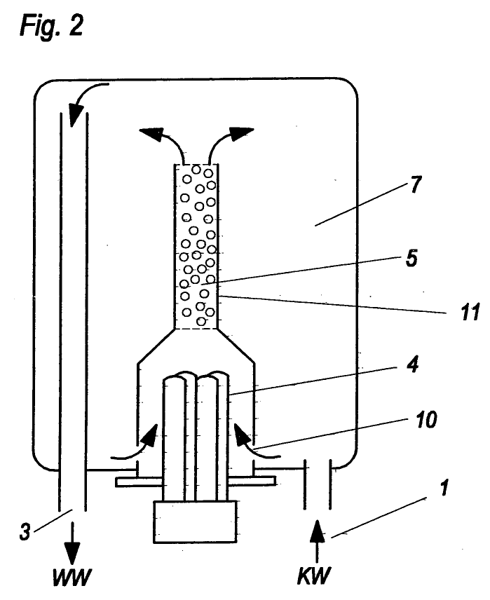

In the Austrian patent specification AT 406 826 B, FIG. 2 shows an embodiment for the use of the catalyst granulate in the hot water circulation. In this specification, a device for disinfecting a water treatment unit is shown, which is introduced as an independent device into the cold water section or hot water section of a drinking water installation. The incorporation of such an additional device entails additional effort and requires additional space. Moreover, this additional device requires an energy supply to heat up the water to be treated. This leads to an additional consumption of energy, which cannot be completely recovered in the drinking water installation, due to the heat losses occurring.

Circulation via the catalyst granulate in a wall-mounted electric boiler by means of a circulation pipe is known.

However, the technical solution with the circulation pipe has two decisive disadvantages:

A circulation pipe with a circulation pump and energy for its operation are required

There are heat losses due to the circulation

These disadvantages disturb the otherwise perfect ecological and economic balance of catalyst technology: the process itself, the formation of the seed crystals, requires no chemical additives—it is a “chemistry-free” process—and no energy, as the energy needed for the formation is stored in the supersaturation of the lime-containing aqueous solution. The subsequent fitting of a circulation pipe with a circulation pump increases the amount of investment and the operation of circulation gives rise to operating costs. These facts, in particular in the case of small plants, have a particularly adverse effect on whether the customer decides in favour of the technology. Moreover, in the case of layered reservoirs, circulation through the reservoir is problematic.

The object of the invention is therefore to integrate a water treatment unit into the drinking water installation so that it gives rise to no additional space and energy requirement, and enables optimum water treatment.

This is achieved according to the invention by arranging the actual treatment unit inside a water heater.

Thus, according to the invention, the water-treating substance, preferably the catalyst granulate, is integrated in an industrial liquid-filled plant directly in the section where e.g. the lime problems occur. Depending on the design of the plant, industrial designs adapted to it are necessary for the container of the water-treating substance, preferably the granulate. In accordance with requirements, the industrial plant itself is not only provided to hold the water-treating substance, preferably the catalyst granulate, but fulfils another industrially necessary purpose. This can e.g. be the supply (storage, buffering) of a liquid, in particular reservoirs of hot water (energy storage) for later use. Alternatively, however, the industrial plant can also serve to heat the liquid, convey the liquid or a combination of the named functions. Through the fitting of a water treatment unit according to the invention, which contains the water-treating substance, preferably the catalyst granulate, the formation of limestone for example can be prevented. Essential characteristics of this device are that it is not itself suitable for providing the water heating and storage function, and that it serves to hold the water-treating substance, preferably the catalyst granulate. In addition, it has a modest flow-through capacity, so that, due to the convection current resulting from the heating, the water-treating substance, preferably the catalyst granulate, can flow through sufficiently, and the protective lime crystals can be distributed throughout the reservoir.

This is the most favourable ecologically and economically, as the catalyst granulate is integrated directly into the respective water heater at a suitable position. Suitable positions are places in the water heater which are sufficiently warm during normal operation of the water heater and which are optimally covered by the heat convection in the water heater. The decisive advantage of this method of use is that it saves the additional installation of independent water-treatment devices containing a pressure-resistant cartridge with flow-guide elements, connection fittings, thermal insulation, and control electronics.

A preferred version provides that the water heater is a boiler, and the treatment unit is arranged so that water heated to preferably at least 50° C. flows through it, having been heated up by the heating element. According to the process, it is moreover favourable for the treatment unit to be arranged in immediate proximity to—preferably above—the heating element. These forms of development according to the invention enable a particularly efficient arrangement of the treatment unit according to the invention in water heaters. In this application, the apparatus according to the invention is provided for water heaters which hold at least a volume of 5 litres, preferably at least a volume of 20 litres.

The apparatus according to the invention can also be developed so that it can be used in water heaters, such as e.g. water boilers or coffee makers, and there efficiently prevent e.g. calcification of the water heater.

A further version according to the invention provides that the water-treating substance, preferably the catalyst granulate, is introduced into a suitable container (walls made of filter mesh), and can be simply mounted in the washing liquid drum in a washing machine. Due to the drum movement, the washing water can flow through the granulate several times, and in the case of lime treatment, the granulate efficiently accumulates lime crystals. Besides protecting the heating rod, the lime crystals can also possibly reduce detergent, which has a positive effect on the whole washing process.

A particularly preferred version of the apparatus according to the invention provides that the treatment unit is a unit for reducing limestone formation. One variant of this provides that seed crystals are released into the surrounding water by the device according to the invention. In this preferred version, it is particularly to be emphasized that the water-treating substance of the treatment apparatus—preferably the catalyst granulate—does not become exhausted.

In addition a preferred embodiment provides that the water-treating substance of the treatment device, preferably the catalyst granulate, can be regenerated.

A possible version according to the invention is that the water-treating substance, preferably present in granulate form, is a weakly acidic ion-exchange material, preferably in the Ca form. Such an ion-exchange material, as well as a process and a device for the conversion of a preferably weakly acidic ion-exchange material from the H form to the Ca form is known from the Austrian patent AT 407 843 B.

In order to use the device according to the invention, individual solutions must be sought for many different water heaters. In this connection it is advisable to enter into agreements with the producers of water preparation equipment which serves other purposes (OEM).

Further characteristics and details of the present invention result from the following description of figures. There are shown in:

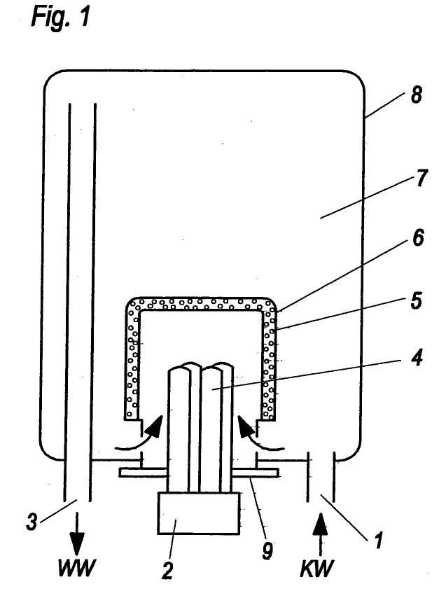

FIGS. 1 to 5 various embodiments according to the invention, of the integration of a treatment unit in a boiler,

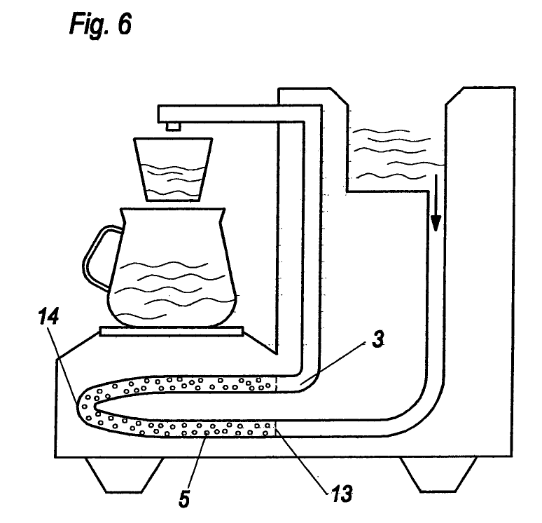

FIG. 6 integration according to the invention of a treatment unit into a coffee maker.

FIG. 1 shows the integration of a water treatment unit in a wall-mounted boiler 8 with electric heating 2. The catalyst granulate 5 is preferably enclosed in a ring-shaped cylindrical container 6, the walls of which are constructed from a filter mesh or a slit or aperture mask. The thickness of the ring-shaped cylinder 6 should not exceed 1 cm, in order not to prevent the transport of water through the catalyst granulate. The ring-shaped cylinder is best fixed to the heating flange 8 in such a way that the heating elements 4 are enclosed by the cylinder.

Alternatively, the ring-shaped cylinder 6 can be clamped to the hot water outlet pipe 3 present in the boiler 8 by means of collars (surrounding the heating elements or immediately above the heating elements).

FIG. 2 shows a variant in which the water treatment unit 11 is constructed as a flow pipe above the electric heating elements 4. During the heating phase, cold water enters through the inlet openings 10 at the lower end of the flow pipe 11, and is heated on the heating elements 4 and then rises upwards over the granulate bed. Due to the convection vortex, the water is mixed and again pushed downwards, so that the water to be treated flows past the catalyst granulate 5 several times.

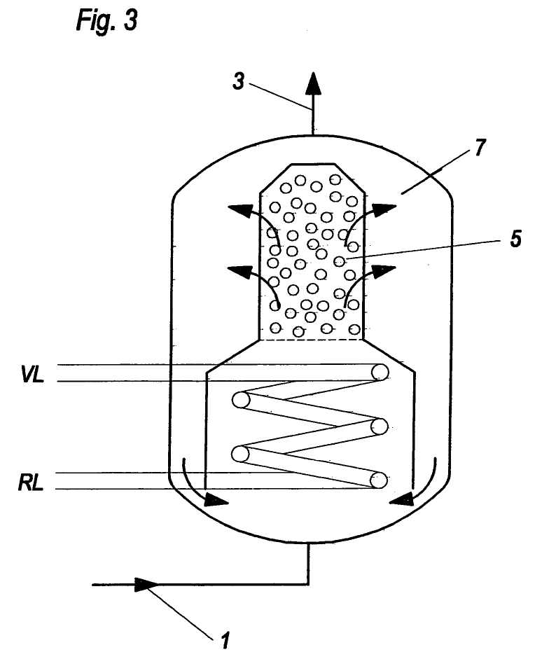

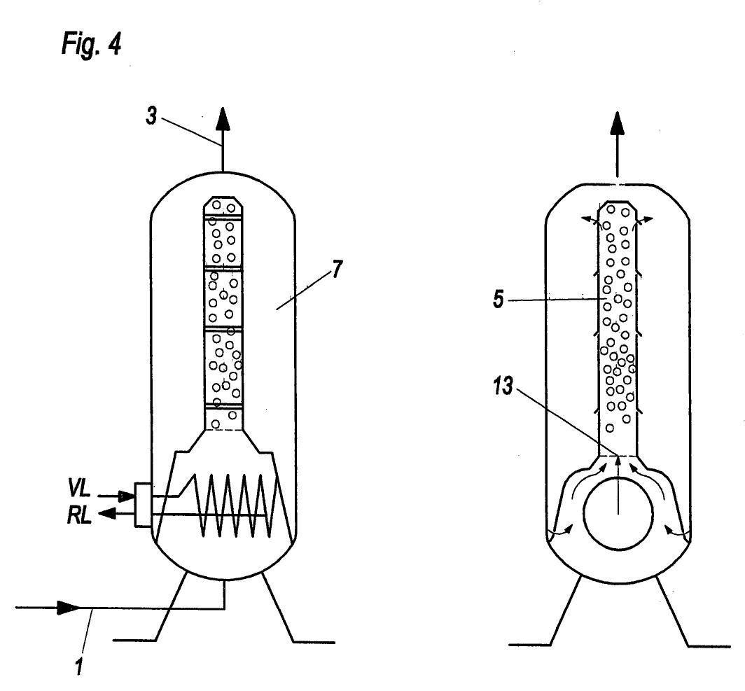

FIGS. 3 and 4 show similar embodiments for standing boiler variants customary in the trade with internal heat exchangers.

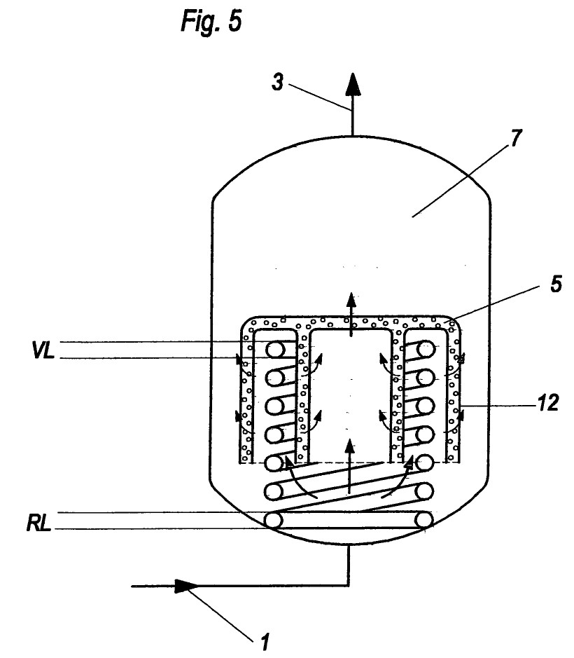

FIG. 5 shows the use of catalyst granulate 5 in a reservoir with a spiral heat exchanger. For this situation, it is recommended to suspend a special filtering basket 12 with catalyst granulate 5 in the area between the heating pipes. The filtering basket 12 can in turn be designed for example as a ring-shaped cylinder.

In summary, FIGS. 1 to 5 show different designs of containers for holding the water-treating substance, preferably the catalyst granulate, which are fitted in the reservoir-water heater. The actual purpose of the industrial plant is the heating and storage of the hot water. In the case of hard water, lime deposits then occur, which lead to technical problems and unserviceability.

FIG. 6 shows a solution according to the invention for a mass-produced coffee maker with catalyst technology. Here the catalyst granulate 5 is integrated directly into the heating section. In most coffee makers, the heating section is designed in the form of an externally heated (bent) pipe 14. For most popular coffee makers, approximately 10 ml of catalyst granulate is introduced into this heating pipe 14. The granulate 5 is kept inside the pipe by means of a filter piece 13.3 at the water inlet and water outlet.

The solution according to the invention shown in FIG. 6 for a coffee maker is only one example of the use of the treatment unit according to the invention in a flow heater. Similarly, a plate heat-exchanger can be filled with the catalyst granulate on the process water side. The actual purpose of the flow heater is to heat and convey the liquid. For this purpose, the flow heater or the plate heat exchanger must have sufficient heating capacity to provide the required hot water within the required time. The purpose of the heating efficiency is therefore not, as e.g. in FIG. 1 of the patent specification EP 0 970 010 A1, to heat the volume of water and hence the catalyst granulate inside the flow heater for the purpose of thermal disinfection, even though this is a welcome side effect.

The technical design requires a certain necessary adaptation to the flow heater or plate heat exchanger, in order to keep the water-treating substance, preferably the catalyst granulate, in the area provided for it.

In addition to a catalytically active ion-exchange material, the treatment unit can also treat the drinking water in another way, in particular in order to avoid or reduce limestone formation. For example, ion exchangers or catalytically active polymers which can be regenerated are possible as water-treating substances.

1. Apparatus for the treatment of drinking water, characterized in that the actual treatment unit is arranged inside a water heater.

2. Apparatus according to claim 1, characterized in that the water heater is a boiler (8) and the treatment unit is arranged so that water heated to preferably at least 50° C. flows through it, having been heated up by the heating element (4).

3. Apparatus according to claim 2, characterized in that the treatment unit is arranged in direct proximity to—preferably above—the heating element (4).

4. Apparatus according to claim 1, characterized in that the water heater is a water boiler or a coffee maker or a washing machine.

5. Apparatus according to one of claims 1 to 3, characterized in that the water heater contains at least a volume of 5 litres, preferably at least a volume of 20 litres.

6. Apparatus according to one of claims 1 to 5, characterized in that the treatment unit is a unit for the—preferably physical—reduction of limestone formation.

7. Apparatus according to one of claims 1 to 6, characterized in that in the treatment unit, lime crystals are formed and released into the water flowing through.

8. Apparatus according to one of claims 1 to 7, characterized in that the water-treating substance (5)—preferably in granulate form—of the treatment unit is a catalytically active substance, preferably a polymer material.

9. Apparatus according to one of claims 1 to 7, characterized in that the water-treating substance (5)—preferably in granulate form—of the treatment apparatus is an ion-exchange material.

10. Apparatus according to one of claims 1 to 9, characterized in that the water-treating substance (5), preferably present in granulate form, is a weakly acidic ion-exchange material, preferably in the Ca form.
